(19) United States
(12) Patent Application Publication
(10) Pub. No.: US 2008/0100716 A1
(43) Pub. Date: May 1, 2008

(54) Estimating A Point Spread Function Of A Blurred Digital Image Using Gyro Data

(76) Inventors: Guoyi Fu, Toronto (CA); Juwei Lu, Toronto (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/838,750

(22) Filed: Aug. 14, 2007

Related U.S. Application Data
(60) Provisional application No. 60/863,875, filed on Nov. 1, 2006.

(51) Int. Cl. H04N 5/228

(52) U.S. Cl. 348/208.8; 382/255; 382/261

(57) ABSTRACT

Methods for estimating a point spread function of a blurred digital image. One example method includes capturing gyro data during an image exposure time, deriving gyro samples from the gyro data at predetermined gyro sampling times, calculating a motion vector field of the image at each gyro sampling time, approximating an overall image scene motion path by averaging motion paths of selected pixels in the image, and estimating the point spread function from the approximated overall image scene motion path.

### CROSS-REFERENCE TO RELATED APPLICATION

This application claims priority to U.S. Provisional Patent Application Ser. No. 60/863,875, filed on Nov. 1, 2006, which is incorporated herein by reference in its entirety.

### THE FIELD OF THE INVENTION

The present invention relates to image processing. More specifically, embodiments of the present invention relate to methods and systems for reducing blur within a digital image.

### BACKGROUND

Image capture devices such as digital cameras have become very popular due in part to the reduction in their cost of production, increase in overall quality, and particularly because camera functionality is being embedded into other electronic consumer devices such as cellular telephones and personal digital assistants (PDAs).

Image blur due to unsteady hand movement or the like during an image capture operation is often difficult to avoid for the inexperienced photographer or for a user with an unsteady hand. Such blur in an image is frustrating, as it can be difficult to avoid, and detracts from the appeal of the image. With standard auto-exposure functions in image capture devices, low-light conditions are compensated for by lowering the shutter speed of the camera, thereby increasing the exposure time in order to capture a bright enough image. This increase in exposure time increases the likelihood that movement will occur during the exposure time, thus increasing the likelihood of blur. The same situation may occur where high-speed camera movement has occurred during image capture, where the exposure time is otherwise normal.

Methods are known for post-processing a captured image by measuring an extent of blur, and correcting for the measured blur. However, under certain conditions—such as low-light and/or very high speed conditions that cause extensive blur—the extent of the blur can be so great that know methods of post-processing cannot restore the image.

### SUMMARY OF EXAMPLE EMBODIMENTS

In general, example embodiments of the invention relate to methods for estimating a point spread function (“PSF”) of a blurred digital image using gyro data. The movement of a camera during exposure can consist of complex motions. For example, due to the camera distortion and rotation around the Z-axis, the motion of the image scene may not be spatially uniform. These complex motions can result in complex motion blur in the resulting digital image. The motion blur in a digital image can be modeled by a process of convolution with a PSF. Example methods disclosed herein can estimate or calculate the PSF more accurately than previously known methods. By providing a methodology that calculates the PSF more accurately, the motion blur in a resulting image can be more completely corrected—even in images having extensive blur. In one example embodiment, the accuracy of the PSF can be further improved by employing high sampling rates for gyro data or using interpolated gyro samples.

In a disclosed example embodiment, a method for estimating a point spread function of a blurred digital image includes capturing gyro data during an image exposure time. Gyro samples are then derived from the gyro data at predetermined gyro sampling times. A motion vector field of the image is then calculated at each gyro sampling time, and an overall image scene motion path is approximated by averaging motion paths of selected pixels in the image. The point spread function (PSF) from the approximated overall image scene motion path can then be estimated/calculated, and thereafter used to compensate or otherwise correct for blur in the resulting image. The advantage is clearer, more blur-free images, even under conditions that otherwise result in blurred images.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

These and other aspects of example embodiments of the invention will become more fully apparent from the following description and appended claims.

### BRIEF DESCRIPTION OF THE DRAWINGS

FIG. 1 discloses an example method for estimating a point spread function (“PSF”) of a blurred digital image using gyro data;

FIG. 2 discloses gyro sample extraction using linear interpolation;

FIG. 3 discloses an example of a relative scene motion path projected in an image coordinate system; and

FIG. 4 discloses an example of a motion point located between pixels.

### DETAILED DESCRIPTION OF EXAMPLE EMBODIMENTS

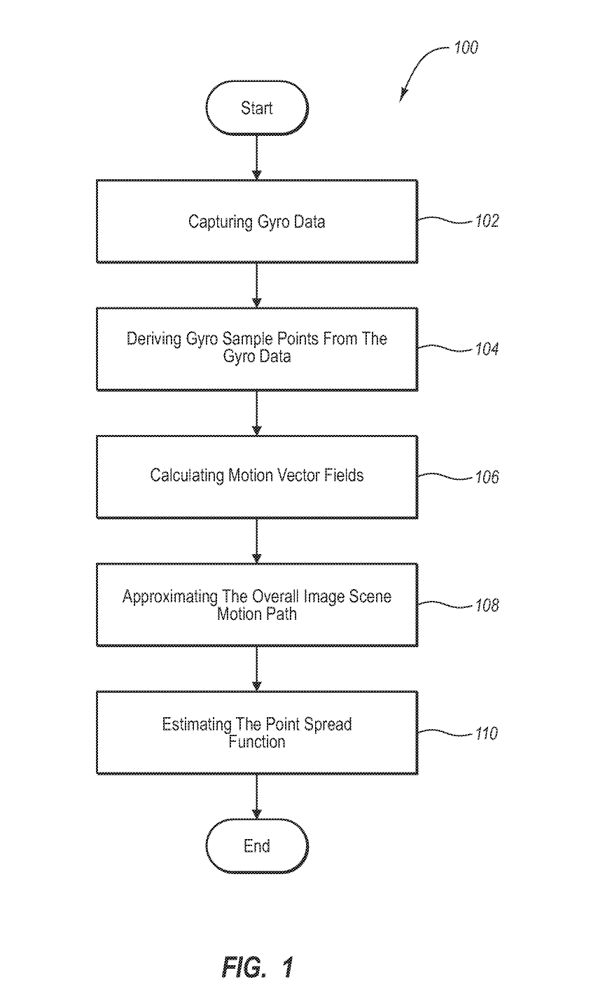

In general, example embodiments relate to methods for estimating a point spread function (“PSF”) of a blurred digital image using gyro data. FIG. 1 discloses an example method 100 for estimating a PSF of a blurred digital image. The example method 100 and variations thereof disclosed herein can be implemented using computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter is described herein in language specific to methodological acts, it is to be understood that the subject matter defined in the appended claims is not necessarily limited to the acts described herein. Rather, the acts described herein are disclosed as example forms of implementing the claims.

The example method 100 for estimating a PSF of a blurred digital image will now be discussed in connection with FIG. 1. Prior to performing the method 100, a blurred digital image I is captured using a gyro-based digital camera. A gyro-based digital camera can be a digital camera that is equipped with one or more gyros.

At 102, gyro data is captured during an image exposure time. For example, the gyro-based digital camera referenced above can be used to capture gyro data during the exposure time of the blurred digital image I. In one example embodiment, the exposure time of the blurred digital image I is defined as the time period between the opening and closing of the shutter of the digital camera, referred to as the shutter open time and the shutter close time, respectively. However, other exposure time periods might also be used.

The gyro data captured at 102 can include the angular velocities of the digital camera at a constant time interval Δt. For example, the gyro data can include angular velocity, Gx, Gy and Gz about X-, Y- and Z- axes as well as a timestamp for each gyro sample. The timestamp for each gyro sample may be relative to the shutter open time or relative to some other time. The rotated angles at each gyro sampling time can then be calculated relative to the shutter open time or relative to some other time.

In order to improve the accuracy of the PSF, some example methods may employ high sampling rates for the gyro data captured at 102. For example, a sampling rate greater than 100 gyro samples per second might be employed. Other example methods may employ interpolated gyro samples. For example, by assuming that the motion of the digital camera between two gyro sampling times is linear, additional sampling times can be linearly interpolated to simulate a higher sampling rate such as 10,000 gyro samples per second, for example. Depending on the accuracy required, different sampling rates and/or interpolation rates may be employed.

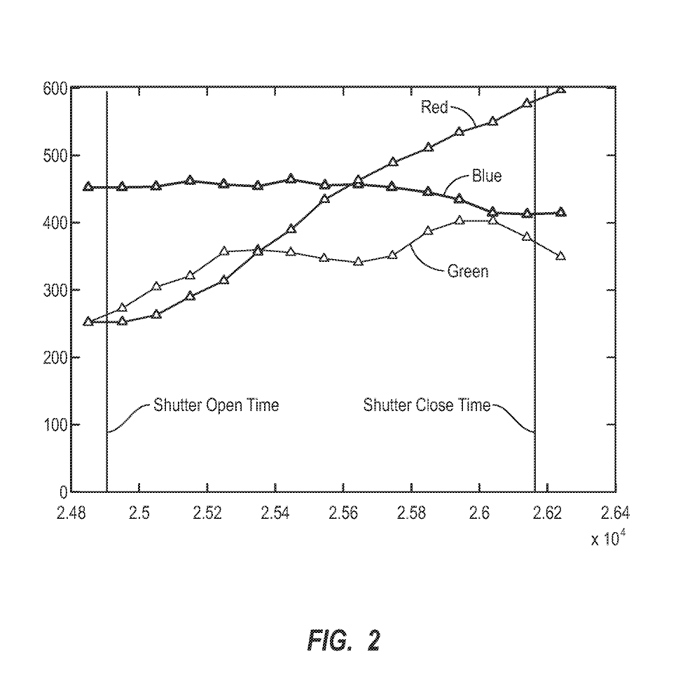

At 104, gyro samples are derived from the gyro data at predetermined gyro sampling times. For example, gyro samples between shutter open and shutter close can be extracted from the gyro data. Linear interpolation may be employed to obtain the gyro samples at the shutter open time and at the shutter close time, respectively. For example, as disclosed in FIG. 2, the actual sampling rate of the gyro samples may result in gyro samples before and after the shutter open time but not at the shutter open time. Therefore, linear interpolation can be employed to calculate the gyro sample at the shutter open time using the gyro samples immediately before and after the shutter open time. Linear interpolation can be similarly employed to calculate the gyro sample at the shutter close time using the gyro samples immediately before and after the shutter close time.

At 106, a motion vector field of the image is calculated at each gyro sampling time. For example, these motion vector fields can be calculated from gyro data using the camera projection model described in co-pending U.S. patent application Ser. No. 11/239,521, titled “METHOD AND APPARATUS FOR LIMITING MOTION BLUR IN A DIGITAL IMAGE,” filed Sep. 29, 2005, the disclosure of which is incorporated herein by reference in its entirety. In one example embodiment, calculating a motion vector field at each gyro sampling time comprises calculating the rotated angle since the shutter open time from the angle velocity at each gyro sampling time. The motions paths of selected pixels in the image can be obtained by tracing the motion vectors from each gyro sampling time until the shutter close time.

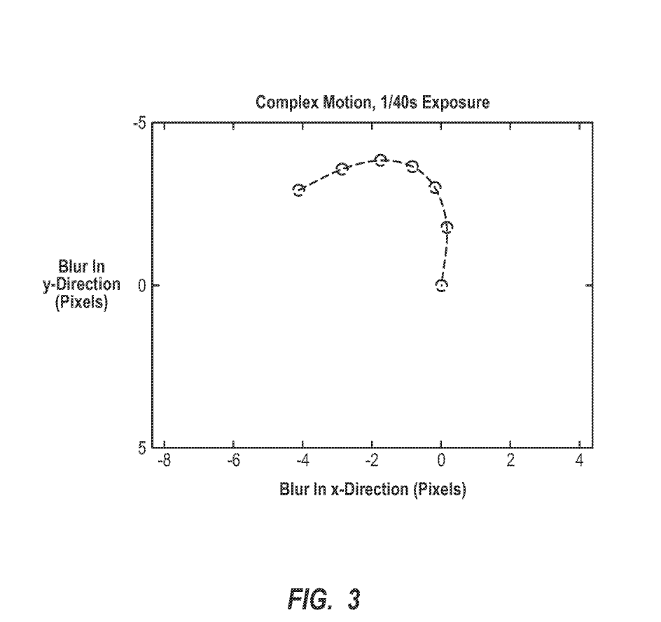

The sequence of positions of the digital camera in a real-world coordinate system can be calculated using the angular velocities of the gyro data. These real-world positions can then be projected onto the coordinate system of the digital image I in order to obtain the relative motion path of the scene represented by the digital image I. An example of a relative motion path projected onto the coordinate system of the digital image is disclosed in FIG. 3.

At 108, the overall image scene motion path is approximated by averaging motion paths of selected pixels in the image. For example, the approximate motion path for overall image can be derived from the average motion paths of nine selected pixels as follows, where H and W are the height and width, respectively, of the blurred digital image I:

| | | |
|---|---|---|
| Top Left (0, 0) | Top Center (0, W/2) | Top Right (0, W) |
| Middle Left (H/2, 0) | Middle Center (H/2, W/2) | Middle Right (H/2, W) |
| Bottom Left (H, 0) | Bottom Center (H, W/2) | Bottom Right (H, W) |

Since the nine pixels are symmetric to the camera principal center, in one example embodiment, the effect of Z-axis rotation may be ignored. In one example embodiment, the average of the nine selected pixel motion paths can be used to approximate the overall motion blur path of the blurred digital image I.

The weighted average of motion paths of the select pixels can be used to estimate the overall motion blur path. For example, the motion blur path can be calculated as follows:

$$\overline{p} ( x , y ) = {\sum }_{i = 1}^{N} {p}_{i} ( x , y ) * {w}_{i} \qquad ( Equation 1 )$$

where pᵢ is the motion path of the ith selected pixel, the wᵢ is the weight for the ith selected pixel. For the case of averaging the motion paths of the nine pixels, the weight can be chosen as follows:

wᵢ=1/N, (i=1 . . . N), and N=9 (Equation 2)

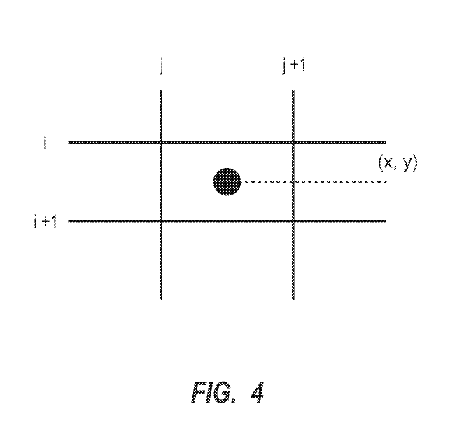

Once the average path for the overall motion path of the image I is obtained, the hits at each gyro sample can be counted. Since the motion path can be calculated to be sub-pixel accurate, a hit can be distributed proportionally to its nearest four neighboring pixels. FIG. 4 disclosed a motion point (x,y) in the motion path at a sampling time which hits between (i, j), (j,j+1), (i+1, j) and (i+1, j+1). The hit can be distributed to these four pixels according to their distance and then accumulate the possibility distributing functions as follows:

P(i,j)=P(i,j)+(j+1−x)*(i+1−y) (Equation 3)

P(i,j+1)=P(i,j+1)+(x−j)*(i+1−y) (Equation 4)

P(i+1,j)=P(i+1,j)+(j+1−x)*(y−i) (Equation 5)

P(i+1,j+1)=P(i+1,j)+(x−j)*(y−i) (Equation 6)

At 110, the PSF is estimated from the approximated overall image scene motion path. For example, the discrete motion samples disclosed in FIG. 3 can be converted into a continuous PSF. To this end, in one embodiment two constraints can be employed to estimate the PSF:

i) an energy conservation constraint:

∫∫h(x,y)=1; and (Equation 7)

ii) a constant radiance constraint:

$${\int }_{t}^{t + Δ t} h ( x ( t ) , y ( t ) ) d t = \frac{Δ t}{{t}_{1} - {t}_{0}} , t ∈ [ {t}_{0} , {t}_{1} - Δ t ] \qquad ( Equation 8 )$$

where t₀ and t₁ are the start and end times of the exposure time. The second constraint states that the amount of energy which is integrated at any time interval is proportional to the length of the interval.

The PSF can be interpreted as the possibility distribution function of a point traveling along the motion path. One example implementation for generating a PSF is disclosed by the following pseudo code:
Input: A sequence of motion blur path samples, (xᵢ, yᵢ), i=1, . . . , N, each one describes a point on the motion path projected in the image coordinate system at the interpolated or sampled gyro sampling time. These points are interpolated or sampled at a constant time interval, Δt.
Output: Two dimensional point spread function (PSF), h(x,y).
Algorithm:
1) Build the PSF based on the interpolated motion path, (xp,yp).
2) Get the motion path's bounds.

xₘᵢₙ=round(min(xp))

xₘₐₓ=round(max(xp))

yₘᵢₙ=round(min(yp))

yₘₐₓ=round(max(yp))
3) Initialize an array h(i,j)=0, i=[1, . . . , (xiₘₐₓ−xiₘᵢₙ+1)], j=[1, . . . ,(yiₘₐₓ−yiₘᵢₙ+1)].
4) For k=1 to N

xx=min(max(xp(j),xiₘᵢₙ),xiₘₐₓ)−xiₘᵢₙ+1;

xi=floor(xx);

xr=xx−xi;

yy=min(max(yp(j),yiₘᵢₙ),yiₘₐₓ)−yiₘᵢₙ+1;

yi=floor(yy);

yr=yy−yi;

h(xi,yi)=h(xi,yi)+(1−xr)·(1−yr);

h(xi+1,yi)=h(xi+1,yi)+xr·(1−yr);

h(xi,yi+1)=h(xi,yi+1)+(1−xr)·yr;

h(xi+1,yi+1)=h(xi+1,yi+1)+xr·yr;
End of for loop
5) Normalization:

$$h = \frac{h}{{\sum }_{x} {\sum }_{y} h ( x , y )}$$

Once the hits of the motion path are counted at each location, the PSF can be normalized to make the sum of PSF equal to one.

What is claimed is:

1. A method for estimating a point spread function of a blurred digital image, the method comprising:
capturing gyro data during an image exposure time;
deriving gyro samples from the gyro data at predetermined gyro sampling times;
calculating a motion vector field of the image at each gyro sampling time;
approximating an overall image scene motion path by averaging motion paths of selected pixels in the image; and
estimating the point spread function from the approximated overall image scene motion path.

2. The method as recited in claim 1, wherein calculating a motion vector field comprises calculating the rotated angle from the angle velocity at each gyro sampling time.

3. The method as recited in claim 1, wherein the image exposure time comprises a time period between a shutter open time and a shutter close time.

4. The method as recited in claim 3, wherein one of the predetermined gyro sampling times includes the shutter open time.

5. The method as recited in claim 4, wherein calculating a motion vector field of the image at the shutter open time comprises linearly interpolating the motion vector field of the image at the shutter open time.

6. The method as recited in claim 3, wherein one of the predetermined gyro sampling times includes a shutter close time.

7. The method as recited in claim 6, wherein calculating a motion vector field of the image at a shutter close time comprises linearly interpolating the motion vector field of the image at the shutter close time.

8. The method as recited in claim 1, wherein capturing gyro data during an image exposure time comprises capturing an angle velocity and timestamp relative to a shutter open time for each gyro sample

9. The method as recited in claim 1, wherein calculating a motion vector field of the image at each gyro sampling time comprises:
obtaining the angle velocity and timestamp of each gyro sample;
calculating the angles rotated at each gyro sampling time relative to shutter open time; and
calculating the motion vector field of the images at each gyro sampling time.

10. The method as recited in claim 1, wherein approximating an overall image scene motion path by averaging motion paths of selected pixels in the image comprises approximating the overall image scene motion path by averaging motion paths of the following nine selected pixels in the image: top left, top center, top right, middle left, middle center, middle right, bottom left, bottom center, and bottom right.

11. One or more computer-readable media having computer-readable instructions thereon which, when executed, implement a method for estimating a point spread function of a blurred digital image, the method comprising:
capturing gyro data during an image exposure time;
deriving gyro samples from the gyro data at predetermined gyro sampling times;
calculating a motion vector field of the image at each gyro sampling time;
approximating an overall image scene motion path by averaging motion paths of selected pixels in the image; and
estimating the point spread function from the approximated overall image scene motion path.

12. The one or more computer-readable media as recited in claim 11, wherein calculating a motion vector field comprises calculating the rotated angle from the angle velocity at each gyro sampling time.

13. The one or more computer-readable media as recited in claim 11, wherein the image exposure time comprises a time period between a shutter open time and a shutter close time.

14. The one or more computer-readable media as recited in claim 13, wherein one of the predetermined gyro sampling times includes the shutter open time.

15. The one or more computer-readable media as recited in claim 14, wherein calculating a motion vector field of the image at the shutter open time comprises linearly interpolating the motion vector field of the image at the shutter open time.

16. The one or more computer-readable media as recited in claim 13, wherein one of the predetermined gyro sampling times includes a shutter close time.

17. The one or more computer-readable media as recited in claim 16, wherein calculating a motion vector field of the image at a shutter close time comprises linearly interpolating the motion vector field of the image at the shutter close time.

18. The one or more computer-readable media as recited in claim 11, wherein capturing gyro data during an image exposure time comprises capturing an angle velocity and timestamp relative to a shutter open time for each gyro sample

19. The one or more computer-readable media as recited in claim 11, wherein calculating a motion vector field of the image at each gyro sampling time comprises:
obtaining the angle velocity and timestamp of each gyro sample;
calculating the angles rotated at each gyro sampling time relative to shutter open time; and
calculating the motion vector field of the images at each gyro sampling time.

20. The one or more computer-readable media as recited in claim 11, wherein approximating an overall image scene motion path by averaging motion paths of selected pixels in the image comprises approximating the overall image scene motion path by averaging motion paths of the following nine selected pixels in the image: top left, top center, top right, middle left, middle center, middle right, bottom left, bottom center, and bottom right.
